(19) United States
(12) Patent Application Publication
(10) Pub. No.: US 2010/0166106 A1
(43) Pub. Date: Jul. 1, 2010

(54) DISCRETE FOURIER TRANSFORM PROCESSING APPARATUS AND RADIO COMMUNICATION APPARATUS

(75) Inventor: Jun KAMEYA, KAWASAKI (JP)

Correspondence Address: Fujitsu Management Services of America, Inc., 2318 Mill Road, Suite 1010, Alexandria, VA, 22314, US

(73) Assignee: FUJITSU LIMITED, KAWASAKI (JP)

(21) Appl. No.: 12/646,595

(22) Filed: Dec. 23, 2009

(30) Foreign Application Priority Data
Dec. 26, 2008 (JP) 2008-331736

(51) Int. Cl. H04L 27/00; G06F 5/01; G06F 17/14

(52) U.S. Cl. 375/295; 708/209; 708/405

(57) ABSTRACT

An arithmetic processing apparatus includes a shift section configured to shift, by (N+1)/2 bit data, a data signal x(n) (n=0, . . . , N−1), which has a data length of N, where N is an odd number, and which has left-right symmetry with respect to ((N−1)/2)th bit data, so as to obtain a data signal x′(n), and an arithmetic operation section configured to obtain a data signal X(k) (k=0, . . . , N−1) by performing a discrete Fourier transform operation on the data signal x′(n).

### CROSS-REFERENCE TO RELATED APPLICATIONS

This application is based upon and claims the benefit of priority of the prior Japanese Patent Application No. 2008-331736, filed on Dec. 26, 2008, the entire contents of which are incorporated herein by reference.

### FIELD

The present invention relates to a discrete Fourier transform processing apparatus and a radio communication apparatus applied to the same.

### BACKGROUND

The standardization of LTE (Long Term Evolution), which is the next-generation mobile communication system evolved from the 3rd generation mobile communication system, is currently being promoted by the 3GPP (3rd Generation Partnership Project). In the 3GPP LTE, it is specified that in order to establish an uplink after a current downlink is established, a PRACH (Physical Random Access Channel) as a random access channel from a mobile terminal to a radio base station is transmitted, and that a Zadoff-Chu sequence having a sequence length of 839 is used for the PRACH (3GPP TS36.211 V8.4.0 5.7 Physical random access channel). The Zadoff-Chu sequence is a signal having a data length of an odd number of data points and having left-right symmetry.

Thus, in the mobile terminal, the Zadoff-Chu sequence having the sequence length of 839 is generated so as to be subjected to cyclic shift processing based on a shift amount determined for each link in the time domain, and thereafter, the 839-point sequence of the Zadoff-Chu sequence is subjected to DFT (Discrete Fourier Transform) processing. Note that in the mobile terminal, the signal having been subjected to the DFT processing is subjected to subcarrier mapping processing for mapping a PRACH to a subcarrier, IFFT (Inverse Fast Fourier Transform) processing for conversion from the frequency domain to the time domain, and CP (Cyclic Prefix) insertion processing for insertion of a CP, so that a PRACH is generated and transmitted to the radio base station.

Here, the Zadoff-Chu sequence is expressed by expression (1).

$$x ( n ) = {e}^{- j \frac{π qn ( n + 1 )}{{N}_{zc}}} , 0 \leq n \leq {N}_{zc} - 1 \qquad [ 1 ]$$

Further, the DFT processing of the Zadoff-Chu sequence is expressed by expression (2).

$$X ( k ) = {\sum }_{n = 0}^{N - 1} x ( n ) \cdot {e}^{- j \frac{2 π nk}{N}} , 0 \leq n \leq N - 1 \qquad [ 2 ]$$

As is apparent from expression (2), complex multiplication is performed N(N−1) times in the DFT processing. For one complex multiplication, real number multiplication is performed 4 times, and hence real number multiplication is performed in total 4N(N−1) times in the DFT processing. In the case where the Zadoff-Chu sequence having the sequence length of 839 is used to transmit the PRACH, since N=Nzc=839, the total number of real number multiplication performed in the DFT processing during transmission of the PRACH is obtained as: the total number of real number multiplication=4×839×(839−1)=2,812,328 times. Thus, a huge amount of multiplication is performed in the processing. As a result, the scale of an arithmetic operation circuit may be increased, and also the load may be significantly increased in terms of the arithmetic processing time and power consumption.

### SUMMARY

According to an aspect of the invention, an arithmetic processing apparatus includes a shift section configured to shift, by (N+1)/2 bit data, a data signal x(n) (n=0, . . . , N−1), which has a data length of N, where N is an odd number, and which has left-right symmetry with respect to ((N−1)/2)th bit data, so as to obtain a data signal x′(n), and an arithmetic operation section configured to obtain a data signal X(k) (k=0, . . . , N−1) by performing a discrete Fourier transform operation on the data signal x′(n).

According to an aspect of the invention, a radio communication apparatus configured to transmit a random access channel by using a data signal x(n) (n=0, . . . , n−1) which has a data length of N bits (N is an odd number) and which has left-right symmetry with respect to ((N−1)/2)th bit data, the radio communication apparatus includes shift section configured to shift the data signal x(n) by (N+1)/2 bits, so as to obtain a data signal x′(n), discrete Fourier transform operation section configured to obtain a data signal X(k) (k=0, . . . , N−1) by performing a discrete Fourier transform operation on the data signal x′(n), and phase rotation operation section configured to perform an operation to rotate the phase of the data signal X(k).

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A and FIG. 1B are figures illustrating a cyclic shift corresponding to a fixed shift amount of the Zadoff-Chu sequence in the present embodiment;

FIG. 2 illustrates a relationship between the approximation of cos θ and the signal deterioration;

FIG. 3 illustrates an example of a schematic configuration of a radio communication apparatus in the present embodiment;

FIG. 4 is a block diagram of a PRACH transmission section of the radio communication apparatus in the present embodiment;

FIG. 5A and 5B illustrate examples of circuit configurations of a fixed cyclic shift section 20, a DFT operation section 30, and a phase rotation section 40 in the PRACH transmission section; and

FIG. 6 is a flow chart of arithmetic processing in the DFT operation section 30.

### DESCRIPTION OF EMBODIMENTS

In the following description, an embodiment of an apparatus disclosed in the present invention will be described with reference to the accompanying drawings. However, the embodiment is not intended to limit the scope of the apparatus disclosed in the present invention.

In the present embodiment, there will be exemplified a case where a mobile terminal, which is a radio communication apparatus for transmitting a PRACH (Physical Random Access Channel) in a LTE (Long Term Evolution) system, performs DFT processing on the Zadoff-Chu sequence.

The DFT processing in the present embodiment is configured to reduce the arithmetic processing amount by using the left-right symmetry of the Zadoff-Chu sequence. The principle of the DFT processing will be described below.

(A) Cyclic shift based on a fixed shift amount of (Nzc+1)/2 points

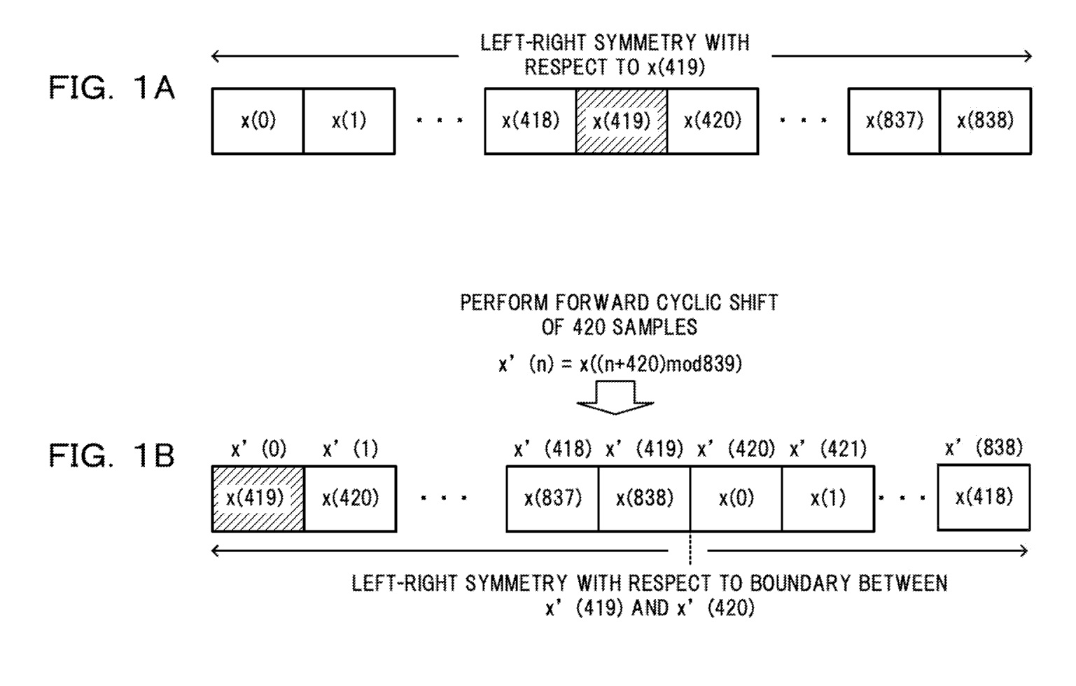

FIG. 1A and FIG. 1B are figures illustrating a cyclic shift corresponding to a fixed shift amount of the Zadoff-Chu sequence.

From expression (1), it can be seen that the Zadoff-Chu sequence exhibits left-right symmetry with respect to the point of x((Nzc−1)/2).

$$x ( n ) = x ( {N}_{zc} - 1 - n ) = {e}^{- j \frac{π qn ( n + 1 )}{{N}_{zc}}} \qquad [ 3 ]$$

That is, as illustrated in FIG. 1A, the values exhibit left-right symmetry with respect to x(419). Thus, for example, x(418)=x(420) and x(0)=x(838). Only x(419) does not have the same value to be paired therewith.

The mobile terminal cyclically shifts forward the Zadoff-Chu sequence by (Nzc+1)/2 points. An arbitrary shift amount, which is changed according to a link established between the mobile terminal and a radio base station, is used in the cyclic shift which is to be originally performed by the mobile terminal. However, here, the cyclic shift is performed with the fixed shift amount of (Nzc+1)/2 points in order to reduce the processing amount. It is assumed that the original cyclic shift is performed in the frequency domain after the DFT processing.

Since x′(n)=x(((N_{zc}+1)/2)mod N_{zc}) and Nzc=839, the cyclic shift of 420 points is performed according to expression (4).

x′(n)=x(420 mod 839) [4]

Then, as illustrated in FIG. 1B, the sequence x′(n), which is obtained after the cyclic shift of 420 points, exhibits left-right symmetry with respect to the boundary between x′(419) and x′(420) in the range of x′(1) to x′(838) (see expression (5)). That is, x′(419)=x′(420) (x′(419) corresponds to x(838) of the original sequence, and x′(420) corresponds to x(0) of the original sequence). Also, x′(1)=x′(838) (x′(1) corresponds to x(420) of the original sequence, and x′(838) corresponds to x(418) of the original sequence). However, x′(0) corresponds to x(419) of the original sequence, and hence there is no symmetrical data only for x′(0).

x′(n)=x′(N_{zc}−n), 1≦n≦N_{zc}−1 [5]

(B) DFT processing of the sequence cyclic-shifted by the fixed shift amount of (Nzc+1)/2 points

The mobile terminal performs the DFT processing on the sequence x′(n) obtained after the cyclic shift of the fixed shift amount of (Nzc+1)/2 points. From expression (2), a signal X(k) subjected to the DFT processing is obtained as expressed by expression (6).

$$X ( k ) = {\sum }_{n = 0}^{{N}_{zc} - 1} {x}^{′} ( n ) \cdot {e}^{- j \frac{2 π nk}{{N}_{zc}}} = {\sum }_{n = 0}^{838} {x}^{′} ( n ) \cdot {e}^{- j \frac{2 π nk}{839}} \qquad [ 6 ]$$

Here, the term of twiddle factor has a relationship represented by expression (7).

$${e}^{- j \frac{2 π ( 839 - n ) k}{839}} = {e}^{j \frac{2 π nk}{839}} \qquad [ 7 ]$$

From expression (5) and expression (7), expression (6) may be transformed as follows.

$$\begin{matrix}X ( k ) = {x}^{′} ( 0 ) + {\sum }_{n = 1}^{419} \{ {x}^{′} ( n ) \cdot {e}^{- j \frac{2 π nk}{839}} + {x}^{′} ( 839 - n ) \cdot {e}^{- j \frac{2 π ( 839 - n ) k}{839}} \} \\ = {x}^{′} ( 0 ) + {\sum }_{n = 1}^{419} \{ {x}^{′} ( n ) \cdot {e}^{- j \frac{2 π nk}{839}} + {x}^{′} ( n ) \cdot {e}^{j \frac{2 π nk}{839}} \} \\ = {x}^{′} ( 0 ) + {\sum }_{n = 1}^{419} {x}^{′} ( n ) ( {e}^{- j \frac{2 π nk}{839}} + {e}^{j \frac{2 π nk}{839}} ) \\ = {x}^{′} ( 0 ) + 2 {\sum }_{n = 1}^{419} {x}^{′} ( n ) cos ( \frac{2 π nk}{839} )\end{matrix} \qquad [ 8 ]$$

When k=0, the term of cos(2πnk/839) becomes 1. Further, from the relation:

$$cos ( \frac{2 π nk}{839} ) = cos ( \frac{2 π n ( 839 - k )}{839} ) ,$$

expression (9) and expression (10) are obtained.

$$\begin{matrix}X ( 0 ) = {x}^{′} ( 0 ) + 2 {\sum }_{n = 1}^{419} {x}^{′} ( n ) & [ 9 ] \\ \begin{matrix}X ( k ) = X ( 839 - k ) \\ = {x}^{′} ( 0 ) + 2 {\sum }_{n = 1}^{419} {x}^{′} ( n ) cos ( \frac{2 π nk}{839} )\end{matrix} , 1 \leq k \leq 419 & [ 10 ]\end{matrix}$$

According to the present embodiment, it is possible to significantly reduce the amount of the DFT processing.

When the DFT processing is performed based on expression (10) as described above, the number of the coefficients of the arithmetic expression is doubled. However, complex multiplication does not need to be performed, and further, the value of k is reduced by half, so that k=419. Thus, the number of times of real number multiplication is obtained as follows:

$$2 \times \frac{( {N}_{zc} - 1 )}{2} \times \frac{( {N}_{zc} - 1 )}{2} = 2 \times 419 \times 419 = 351 , 122$$

Therefore, according to the present embodiment, it is possible to reduce the amount of arithmetic processing as compared with the DFT processing in the related art.

(C) Approximation of cos θ

When the value in the parenthesis of the term cos(2πnk/839) in expression (10) is close to 0 or π, the value of cos(2πnk/839) becomes very close to ±1. In such a case, the term of cos(2πnk/839) may be approximated to ±1. When the term cos(2πnk/839) is approximated by ±1, only the through processing (+1) or the sign inversion processing (−1) may need to be performed as the processing by hardware, and hence it is possible to further reduce the number of times of multiplication. However, in order to prevent the deterioration of signal quality, it is preferred to limit the approximation range.

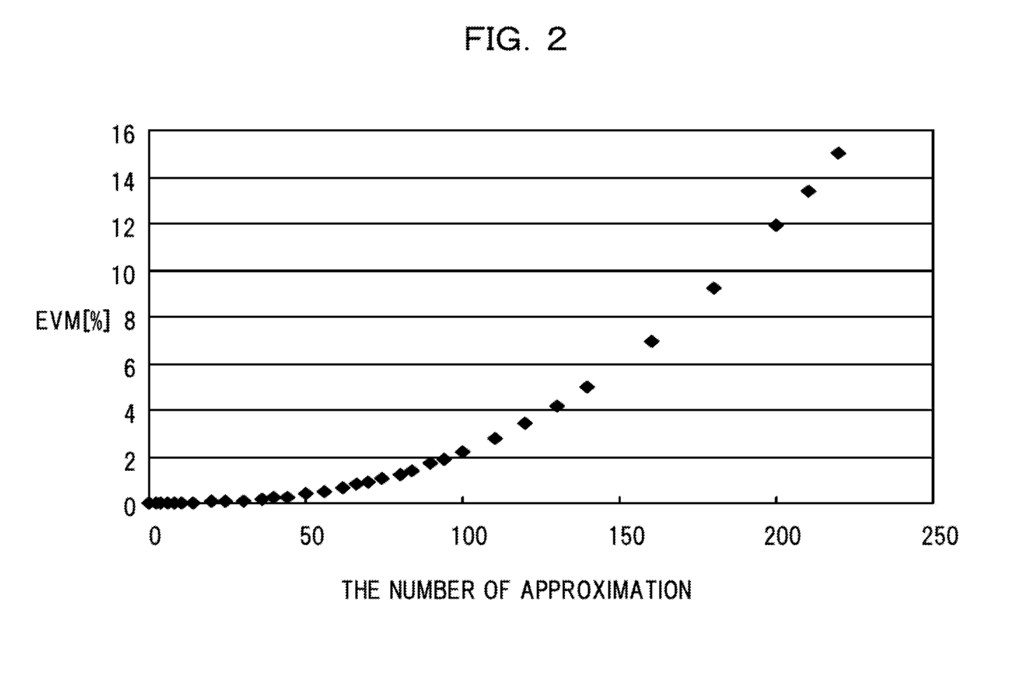

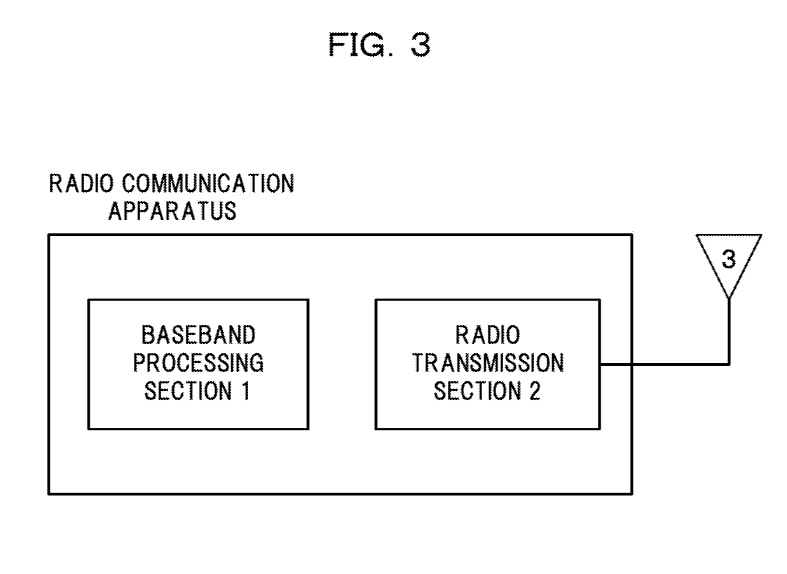

FIG. 2 illustrates a relationship between the approximation of cos θ and the signal deterioration. The term cos(2πm/839) in expression (10) may take 419 kinds of values for m=1, 2, and . . . 419.

When m is close to 1, the value of cos(2πm/839) takes a value very close to +1, while when m is close to 419, the value of cos(2πm/839) takes a value very close to ±1. In these cases, even when the value of cos(2πm/839) is approximated by ±1, the signal is only slightly deteriorated. However, as m is deviated from 1 or 419, the signal deterioration at the time when the value of cos(2πm/839) is approximated by ±1 is increased.

In FIG. 2, the horizontal axis represents the number of cos θ approximated by ±1 (which is obtained by performing the approximation from the side that the absolute value (|cos θ|) of cos θ is close to +1), and the vertical axis represents the signal deterioration by EVM (Error Vector Magnitude). From FIG. 2, it can be seen that when the signal deterioration due to the approximation is permitted within a range up to EVM=1.0%, about 70 kinds of values of cos θ among the 419 kinds of values of cos θ may be approximated by ±1 from the side in which the absolute value of cos θ is close to ±1. In this case, the amount of multiplication processing may be reduced by 70/419×100=16.7%.

Further, when the signal deterioration due to the approximation is permitted within a range up to 14%, about 210 kinds of values of cos θ may be approximated by ±1, and thereby the amount of multiplication processing may be reduced to about 210/419×100=50.1% (about half).

There will be described a configuration of a PRACH transmission section, which performs the DFT processing using the above described approximation, of a radio communication apparatus.

FIG. 3 illustrates an example of a schematic configuration of a radio communication apparatus in the present embodiment. The radio communication apparatus includes a baseband processing section 1 and a radio transmission section 2. The baseband processing section 1 is capable of performing baseband processing, such as digital modulation of a transmission signal, and the PRACH transmission section may be configured as a function of the baseband processing section 1. The radio transmission section 2 converts a digital signal into an analog signal, and transmits the analog signal as a radio signal from an antenna 3.

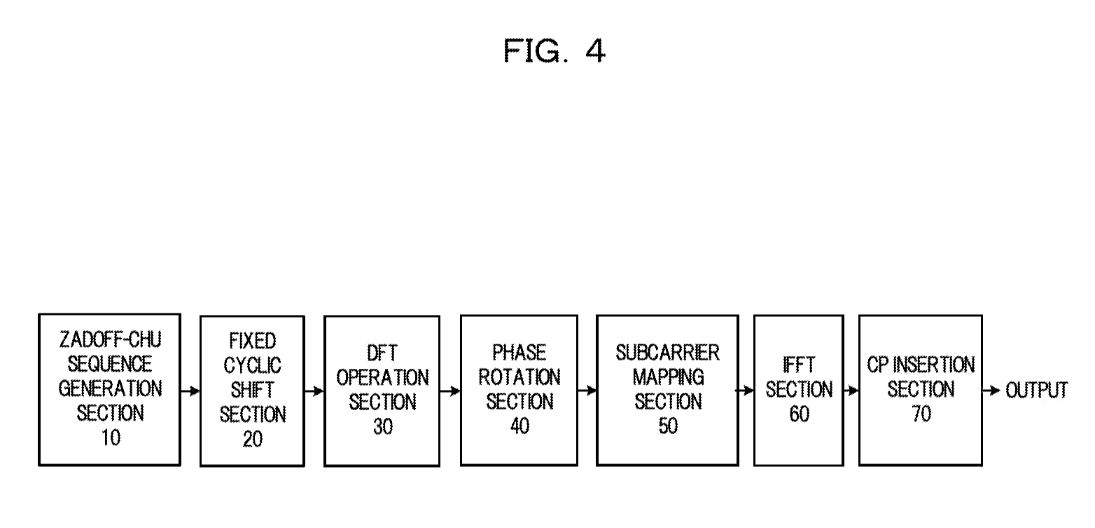

FIG. 4 is a block diagram of the PRACH transmission section of the radio communication apparatus in the present embodiment. The PRACH transmission section includes a Zadoff-Chu sequence generation section 10 which generates a Zadoff-Chu sequence having a sequence length=839, a fixed cyclic shift section 20 which performs a cyclic shift of a fixed shift amount of 420 points in the time domain of the Zadoff-Chu sequence, a DFT operation section 30 which performs a DFT operation using the above described approximation on the cyclically shifted signal sequence, a phase rotation section 40 which performs a cyclic shift in the frequency domain on the signal sequence subjected to the DFT operation, a subcarrier mapping section 50 which maps a PRACH to a subcarrier, an IFFT section 60 which converts the PRACH from the frequency domain to the time domain, and a CP insertion section 70 which inserts a CP (Cyclic Prefix) into the PRACH.

In the present embodiment, the Zadoff-Chu sequence generated by the Zadoff-Chu sequence generation section 10 is cyclically shifted by the fixed shift amount of 420 points, and is then subjected to the DFT operation, so as to be converted into the frequency domain. A cyclic shift in the time domain corresponds to a phase rotation in the frequency domain. Thus, in the present embodiment, the phase rotation section 40 performs the phase rotation processing as the processing which is originally performed in the time domain and which corresponds to the cyclic shift based on the individual shift amount for each link.

The signal subjected to the DFT processing includes the results of the cyclic shift processing of the fixed shift amount of 420 points. Thus, the phase rotation section 40 converts, into a phase rotation amount, the cyclic shift amount obtained by subtracting the fixed shift amount of 420 points from the individual shift amount for each link, and performs phase rotation processing based on the converted phase rotation amount.

The phase rotation in the frequency domain is expressed by expression (11) as follows.

$${X}^{′} ( k ) = X ( k ) \cdot {e}^{j \frac{2 π ( 420 - α ) k}{839}} , 0 \leq k \leq 838 \qquad [ 11 ]$$

Here, α represents an individual shift amount.

In this processing, complex multiplication is performed 839 times, and hence the number of times of real number multiplication becomes 4×839=3,356 times. The amount of multiplication processing is increased by converting the cyclic shift in the time domain into the phase rotation in the frequency domain. However, the increase in the amount of multiplication processing is very small compared with the reduced number of times of multiplication in the

DFT processing (about 2,800,000 times to about 350,000 times), and hence the total number of times of multiplication is significantly reduced.

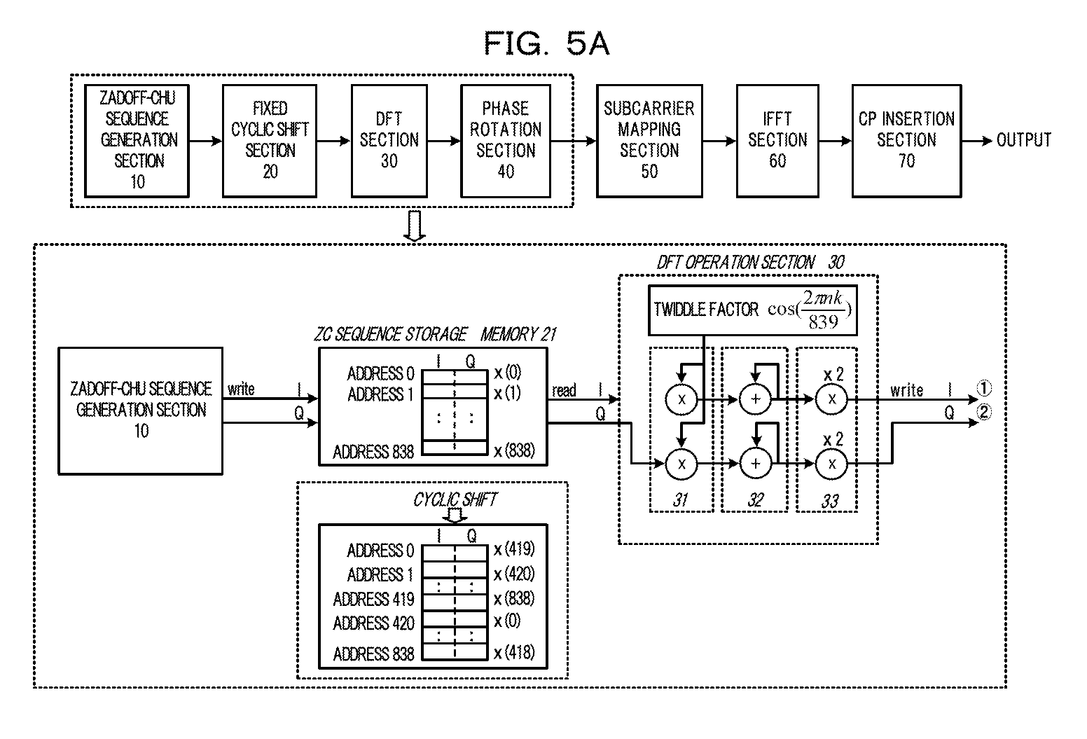

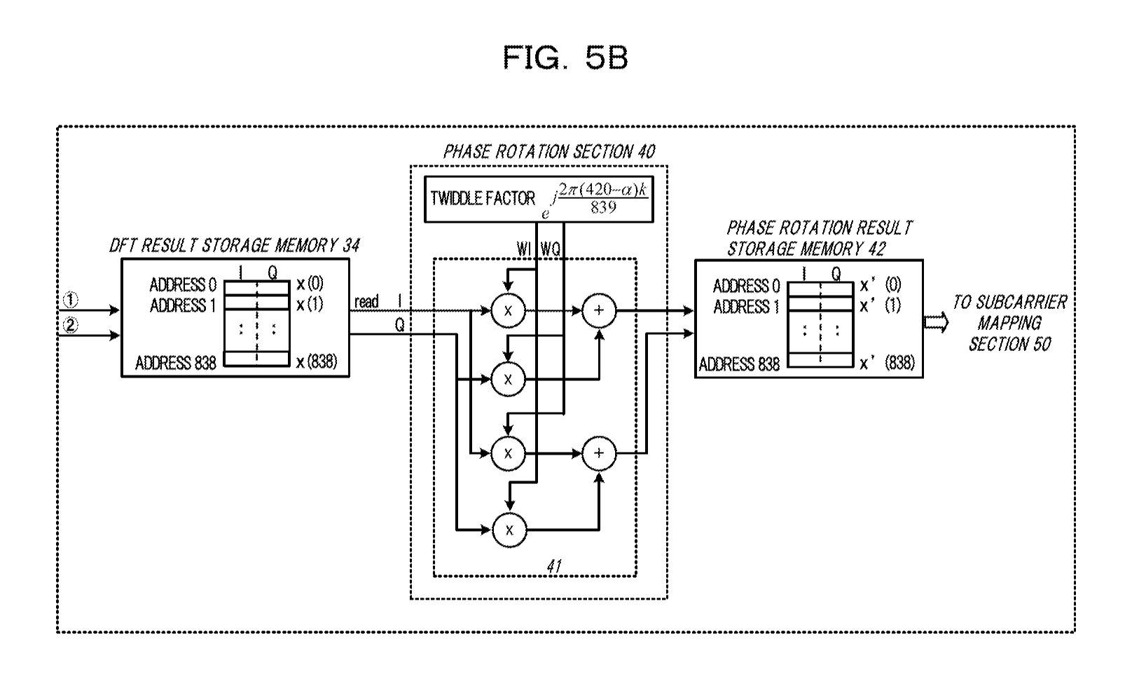

FIG. 5A and 5B are figures illustrating examples of circuit configurations of the fixed cyclic shift section 20, the DFT operation section 30, and the phase rotation section 40 in the PRACH transmission section. The fixed cyclic shift section 20 shifts, by the amount corresponding to 420 addresses, the read-out order from a Zadoff-Chu sequence (hereinafter may be abbreviated as ZC sequence) storage memory 21 which stores the 839-point data (I signals and Q signals) of the Zadoff-Chu sequence generated by the Zadoff-Chu sequence generation section 10.

In order to perform the arithmetic operation of expression (10) described above, the DFT operation section 30 includes multiplication circuit 31, an integration circuit 32, and a doubling circuit (or one-bit shift circuit) 33 for each I signal and Q signal. Note that x(0) has the twiddle factor of cos θ=+1, and hence the multiplication does not need to be performed with respect to x(0). Further, as described above, also when the twiddle factor cos θ is approximated by ±1, the multiplication may not need to be performed. The data (I signals and Q signals) subjected to the DFT processing is stored in a DFT result storage memory 34.

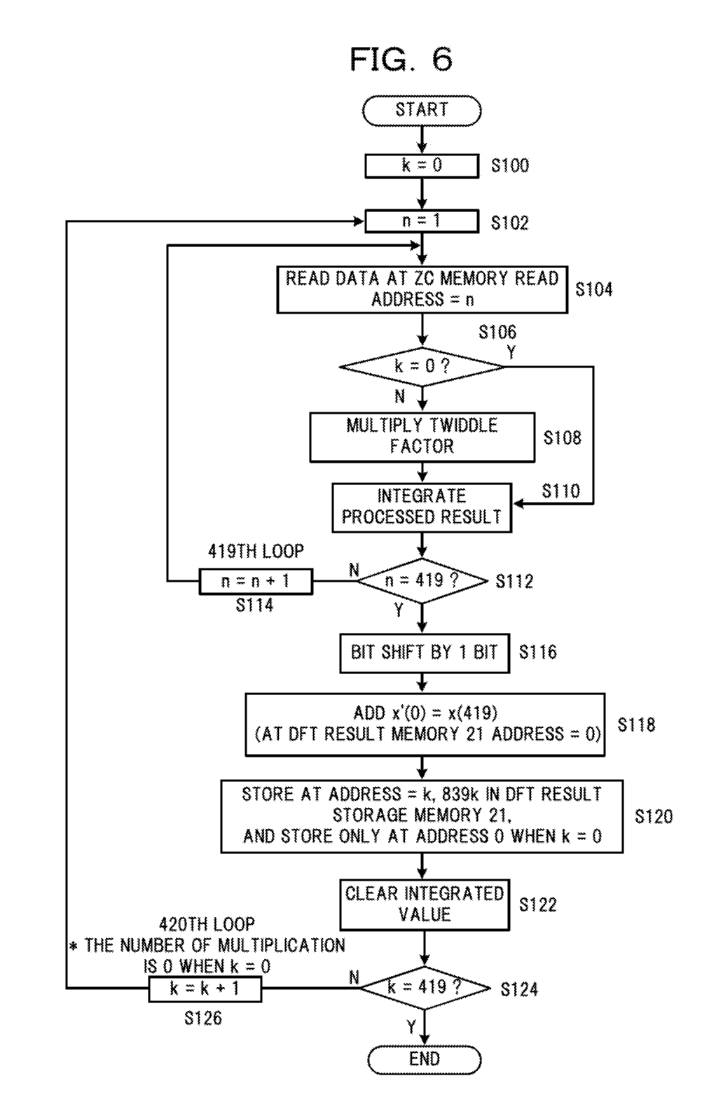

FIG. 6 is a flow chart of the arithmetic processing of the DFT operation section 30. Initial values of k and n are respectively set as k=0 and n=1 (S100, S102). Data of the address=n is read from the ZC sequence storage memory 21 (S104). When k=0 in S106, the multiplication circuit 31 does not perform multiplication. Except when k=0, the multiplication circuit 31 performs the twiddle factor multiplication processing (S108). Subsequently, the integration circuit 32 performs processing to integrate the result of the multiplication processing with the value integrated in the preceding processing (S110). Each time the processing from S104 to S110 is performed, n is counted up by +1 (S114), and the processing from S104 to S110 is repeated until n=419 (S112).

When n=419, the one-bit shift circuit 33 performs one-bit shift processing for doubling the integrated value obtained by the integration processing (S116), and further adds the value of the address=0 (n=0) (corresponding to x′(0)=x(419)) of the DFT result storage memory 34 to the processed value, so as to obtain the value of X(k) of expression (10).

Since X(k)=X(839−k) from expression (10), the obtained X(k) is stored at both addresses k and 839−k of the ZC sequence result storage memory (S120). Note that X(0) is written only at the address=0.

The integrated value X(k) obtained in S118 is cleared (S122). Then, each time the processing from S102 to S122 is performed, k is counted up by +1 (S126), and the processing from S102 to S122 is repeated until k=419 (S124).

The phase rotation section 40 reads the data of 839 points (I signals and Q signals) stored in the DFT result storage memory 34. The phase rotation section 40 includes a complex multiplication circuit 41 for performing the arithmetic operation of expression (11) described above, and performs the phase rotation processing on the data (I signals and Q signals) by using the complex multiplication circuit 41. The phase rotation section 40 stores the processed data in a phase rotation result storage memory 42, and sends the processed data to the subcarrier mapping section 50.

In the present embodiment, the DFT processing of a signal using a Zadoff-Chu sequence is exemplified. However, the present invention is not limited to the Zadoff-Chu sequence, and the DFT processing according to the present embodiment may be applied to a signal which has a data length of an odd number of data points and which has left-right symmetry.

Further, in the present embodiment, the DFT processing performed in a radio communication apparatus of an LTE system is exemplified. However, the present invention is not limited to this, and may be applied to another apparatus which performs the DFT processing on a signal which has a data length of an odd number of data points and left-right symmetry.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. An arithmetic processing apparatus comprising:
a shift section configured to shift, by (N+1)/2 bit data, a data signal x(n) (n=0, . . . , N−1), which has a data length of N, where N is an odd number, and which has left-right symmetry with respect to ((N−1)/2)th bit data, so as to obtain a data signal x′(n); and
an arithmetic operation section configured to obtain a data signal X(k) (k=0, . . . , N−1) by performing a discrete Fourier transform operation on the data signal x′(n).

2. The arithmetic processing apparatus according to claim 1,
wherein the arithmetic operation section performs the discrete Fourier transform operation by using twiddle factors based on a cosine function that includes a value k in an angle component.

3. The arithmetic processing apparatus according to claim 2,
wherein the arithmetic operation section obtains a data signal X(k) (k=1, . . . , (N−1)/2) or a data signal X(N−k) (k=1, . . . , (N−1)/2) by the discrete Fourier transform operation.

4. The arithmetic processing apparatus according to claim 3,
wherein, among the values of k at which absolute values of the cosine function do not become +1, the arithmetic operation section approximates, to +1 or −1, the values of the cosine function corresponding to a certain number of the values of k in order from the absolute value of the cosine function closest to +1.

5. A radio communication apparatus configured to transmit a random access channel by using a data signal x(n) (n=0, . . . , n−1) which has a data length of N bits, where N is an odd number, and which has left-right symmetry with respect to ((N−1)/2)th bit data, the radio communication apparatus comprising:
a shift section configured to shift the data signal x(n) by (N+1)/2 bits, so as to obtain a data signal x′(n);
a discrete Fourier transform operation section configured to obtain a data signal X(k) (k=0, . . . , N−1) by performing a discrete Fourier transform operation on the data signal x′(n); and
a phase rotation operation section configured to perform an operation to rotate a phase of the data signal X(k).

6. The radio communication apparatus according to claim 5, wherein the discrete Fourier transform operation section performs the discrete Fourier transform operation by using twiddle factors based on a cosine function that includes a value of k in an angle component.

7. The radio communication apparatus according to claim 6, wherein the discrete Fourier transform operation section obtains a data signal X(k) (k=1, . . . , (N−1)/2) or a data signal X(N−k) (k=1, . . . , (N−1)/2) by the discrete Fourier transform operation.

8. The radio communication apparatus according to claim 7,
wherein, among the values of k at which absolute values of the cosine function do not become +1, the discrete Fourier transform operation section approximates, to +1 or −1, the values of the cosine function corresponding to a certain number of the values of k in order from the absolute value of the cosine function closest to +1.

9. The radio communication apparatus according to claim 5,
wherein the data signal x(n) (n=0, . . . , n−1) is a Zadoff-Chu sequence, and wherein the random access channel is a physical random access channel in a LTE (Long Term Evolution) system.
